(19) United States
(12) Patent Application Publication
(10) Pub. No.: US 2012/0082216 A1
(43) Pub. Date: Apr. 5, 2012

(54) CODING AND DECODING UTILIZING PICTURE BOUNDARY PADDING IN FLEXIBLE PARTITIONING

(75) Inventors: Limin Wang, San Diego, CA (US); Xue Fang, San Diego, CA (US); Krit Panusopone, San Diego, CA (US)

(73) Assignee: GENERAL INSTRUMENT CORPORATION, Horsham, PA (US)

(21) Appl. No.: 13/247,190

(22) Filed: Sep. 28, 2011

Related U.S. Application Data
(60) Provisional application No. 61/391,350, filed on Oct. 8, 2010.
(60) Provisional application No. 61/388,741, filed on Oct. 1, 2010.
(60) Provisional application No. 61/388,895, filed on Oct. 1, 2010.

(51) Int. Cl. G06K 9/46; H04N 7/26

(52) U.S. Cl. 375/240.08; 382/240; 375/E07.027

(57) ABSTRACT

There is a coding including-preparing coding units based on source pictures. The coding units are associated with largest coding tree units (LCTUs) which are polygons of source pictures. A tree format is utilized in processing the LCTUs into coding units. The preparing includes calculating an efficiency measure associated with a source picture position in a coordinate system based on fitting the coordinate system and the source picture with respect to each other. The preparing includes determining the source picture position based on a coding efficiency goal. The preparing includes determining padding areas. The source picture and padding areas are divided into LCTUs based on the coordinate system and the determined source picture position. The LCTUs are partitioned into coding units based on the tree format and a homogeneity rule. There is also a decoding including processing video compression data which is generated based on the coding units.

### PRIORITY

The present application also claims the benefit of priority to U.S. Provisional Patent Application Ser. No. 61/388,741, filed on Oct. 1, 2010, entitled “Flexible Picture Partitioning”, by Krit Panusopone, et al., and to U.S. Provisional Patent Application Ser. No. 61/388,895, also filed on Oct. 1, 2010, and also entitled “Flexible Picture Partitioning”, by Krit Panusopone, et al., the disclosures of which are hereby incorporated by reference in their entirety.

The present application claims the benefit of priority to U.S. Provisional Patent Application Ser. No. 61/391,350, filed on Oct. 8, 2010, entitled “Arbitrarily Padding”, by Krit Panusopone, et al., the disclosure of which is hereby incorporated by reference in its entirety.

### CROSS REFERENCE TO RELATED APPLICATIONS

The present application is related to U.S. Utility patent application Ser. No. TBD, filed on TBD, entitled “Coding and Decoding Utilizing Picture Boundary Variability in Flexible Partitioning”, by Krit Panusopone, et al., which claims priority to U.S. Provisional Patent Application Ser. No. 61/388,741, filed on Oct. 1, 2010, entitled “Flexible Picture Partitioning”, by Krit Panusopone, et al., and to U.S. Provisional Patent Application Ser. No. 61/388,895, also filed on Oct. 1, 2010, and also entitled “Flexible Picture Partitioning”, by Krit Panusopone, et al., the disclosures of which are hereby incorporated by reference in their entirety.

### BACKGROUND

Video compression utilizes block processing for many operations. In block processing, a block of neighboring pixels is grouped into a coding unit and compression operations treat this group of pixels as one unit to take advantage of correlations among neighboring pixels within the coding unit. Theoretically, a larger coding unit is commonly preferred to reduce the overhead associated with processing multiple smaller coding units instead of one larger coding unit for the same part of a picture. The larger coding unit is also preferred because the bandwidth associated with transmitting information associated with the processing of a single larger coding unit is often lower.

Coding units having block sizes of 8×8 and 16×16 pixels have been utilized in earlier video compression standards; e.g., MPEG-1, MPEG-2 and MPEG-4 AVC. In these earlier standards, a coding system utilized a fixed block size for block processing. Partitioning pictures based on fixed block size is relatively simple. If the processing order is predetermined, such as with a raster scan pattern scanning order, the earlier coding systems merely relied upon a block index to specify a location of a coding unit within a picture area.

High Efficiency Video Coding (HEVC) is a new video compression standard which has been proposed as a successor to MPEG-4 AVC. One goal in developing HEVC is to standardize an improved coding efficiency compared with the “high profile” of MPEG-4 AVC. The high profile of MPEG-4 AVC is associated with high definition television (HDTV). Another goal in developing HEVC is to reduce the bitrate requirements of transmitting HDTV compressed video data while also maintaining comparable image quality with the MPEG-4 AVC high profile.

Among the proposals made for HEVC are those including concepts relating to flexible block size partitioning, or simply flexible partitioning. Flexible partitioning adds flexibility over fixed block size partitioning by utilizing a range of sizes associated with the coding units of a partitioned picture. In flexible partitioning, a picture is initially divided into equal sized square blocks called largest coding tree units (LCTUs). The size of the LCTUs adopted to partition pictures may be substantially higher than the fixed block sizes used in earlier standards. After a picture has been divided into a group of LCTUs, the individual LCTUs in the group are often partitioned into coding units which commonly include a range of sizes. However, in some circumstances an LCTU may not be partitioned. In these circumstances, the LCTU is associated with a single coding unit having a size equivalent to the LCTU.

The partitioning of an LCTU is commonly performed utilizing a quadtree format. The quadtree format is a recursive partitioning process following a tree structure having layers. At the top layer, the complete LCTU is a parent of the quadtree. If there is no partitioning, the complete LCTU is also a coding unit. In flexible partitioning according to the quadtree format, the parent is commonly divided into four leaves. Each leaf represents an equivalent size quadrant of the parent and are square blocks. A leaf in the quadtree may also form a coding unit or be further partitioned. A leaf which is further partitioned is a parent of its leaves in the next layer of the quadtree.

A quadtree of a parent LCTU often continues to be divided recursively through one or more leaves at different layers. The unpartitioned leaves at each layer commonly form coding units of different sizes, all being based on the parent LCTU. The unpartitioned leaves at each layer represent coding units having a predetermined condition, such as a measure of homogeneity associated with the pixels in a coding unit. The quadtree format is commonly utilized in video processing applications due to its efficiency in representing pictures. The recursive nature of the quadtree, in general, requires little overhead to represent the various sized coding units of a parent LCTU.

In the HEVC models which have been considered, pictures are commonly divided into LCTUs utilizing a coordinate system, such as a Cartesian coordinate system. A complete picture occupies only that part of a single quadrant of the coordinate system which is closest to the origin. The coordinate system marks the location of all the LCTUs in a group of LCTUs associated with a picture outlined by a picture boundary. The LCTUs in this group are marked by the coordinate system with respect to the picture. Also, the lengths of the axes nearer the origin of the coordinate system, on the boundaries of the single quadrant, contact two of the picture's boundaries. Block processing according to these HEVC models has certain inefficiencies.

One reason for the inefficiencies is due to picture boundary issues. Picture boundary issues often arise when a picture has pixels in areas which fall into incomplete LCTUs located farther from the coordinate system axes. These LCTUs are irregular due to the picture boundary of the fixed picture not extending to fill these boundary issue LCTUs. This is a boundary issue that commonly occurs when a height or length of a picture are not some complete multiple of the dimensions of an LCTU size used for block processing the picture.

Another reason for the inefficiencies is because the locations of the LCTUs with respect to the picture are all fixed, the quadtree format often necessitates recursively dividing an LCTU into very small coding units in order to attain a measure of homogeneity associated with the pixels in all the partitioned coding units of the LCTU. A greater number of small coding units often requires a higher overhead to generate and process all the coding units associated with a picture. Also more bandwidth is commonly required to transmit compression data associated with the greater number of small coding units when packaged in a compressed video bitstream. Nevertheless, when the location of the picture within a coordinate system is changed, this often increases inefficiencies associated with boundary issues which commonly offset the efficiencies gained by relocating the picture within the coordinate system.

In the HEVC models which have been considered, attempts to address boundary issues commonly include iteratively partitioning the quadtree format leaves of the boundary issue LCTUs (i.e., those LCTUs containing at least some area the picture to form coding units) while ignoring the leaves in the boundary issue LCTUs which contain no area of the picture. The partitioning repeats with the leaves containing a part of the picture until these partitioned leaves become square in shape. This methodology in attempting to address the boundary issue often causes degradation in coding efficiency. It commonly requires the coding units in the boundary issue LCTUs to be partitioned into smaller blocks than optimal. The degradation in coding efficiency in these circumstances is more common when larger LCTU sizes are utilized and/or when the pictures being partitioned involve lower video resolutions.

### SUMMARY

According to principles of the invention, there are systems, methods, and computer readable mediums (CRMs) which provide for coding and decoding utilizing picture boundary padding. By utilizing picture boundary padding, boundary issue inefficiencies in flexible partitioning are reduced. These include those inefficiencies based on boundary issues associated with LCTUs and/or pictures being freely located with respect to each other so that larger coding units may be partitioned. Picture boundary padding increases the coding efficiency associated with the processing overhead and/or bandwidth required to generate and/or to transmit video compression data associated with the coding units prepared utilizing picture boundary padding.

According to a first principle of the invention, there is a system for coding. The system may include a processor configured to prepare coding units based on source pictures. The preparing may include calculating an efficiency measure associated with one or more potential source picture positions in a coordinate system based on fitting the coordinate system and one or more source pictures with respect to each other. The coordinate system includes two perpendicular axes in a plane intersecting at an origin of the coordinate system and dividing the plane into four quadrants meeting at the origin. The preparing may also include determining a source picture position for the source picture in the coordinate system based on the calculated efficiency measure, the potential source picture position and a coding efficiency goal. The preparing may also include determining one or more padding areas based on the determined source picture position(s). The preparing may also include dividing the source picture and the determined padding area(s) into a plurality of LCTUs based on the determined source picture position.

According to a second principle of the invention, there is a method for coding. The method may include preparing coding units based on source pictures utilizing a processor. The preparing may include calculating an efficiency measure associated with one or more potential source picture positions in a coordinate system based on fitting the coordinate system and one or more source pictures with respect to each other. The coordinate system includes two perpendicular axes in a plane intersecting at an origin of the coordinate system and dividing the plane into four quadrants meeting at the origin. The preparing may also include determining a source picture position for the source picture in the coordinate system based on the calculated efficiency measure, the potential source picture position and a coding efficiency goal. The preparing may also include determining one or more padding areas based on the determined source picture position(s). The preparing may also include dividing the source picture and the determined padding area(s) into a plurality of LCTUs based on the determined source picture position.

According to a third principle of the invention, there is a non-transitory CRM storing computer readable instructions which, when executed by a computer system, performs a method for coding. The method may include preparing coding units based on source pictures utilizing a processor. The preparing may include calculating an efficiency measure associated with one or more potential source picture positions in a coordinate system based on fitting the coordinate system and one or more source pictures with respect to each other. The coordinate system includes two perpendicular axes in a plane intersecting at an origin of the coordinate system and dividing the plane into four quadrants meeting at the origin. The preparing may also include determining a source picture position for the source picture in the coordinate system based on the calculated efficiency measure, the potential source picture position and a coding efficiency goal. The preparing may also include determining one or more padding areas based on the determined source picture position(s). The preparing may also include dividing the source picture and the determined padding area(s) into a plurality of LCTUs based on the determined source picture position.

According to a fourth principle of the invention, there is a system for decoding. The system may include an interface configured to receive video compression data. The system may also include a processor configured to process the received video compression data. The received video compression data may be based on coding units, based on source pictures. The coding units may be prepared by steps including calculating an efficiency measure associated with at least one potential source picture position in a coordinate system based on fitting the coordinate system and at least one source picture with respect to each other, The coordinate system may include two perpendicular axes in a plane intersecting at an origin of the coordinate system and dividing the plane into four quadrants meeting at the origin. The steps may also include determining a source picture position for the source picture in the coordinate system based on the calculated efficiency measure, the potential source picture position and a coding efficiency goal. The steps may also include determining one or more padding area(s) based on the determined source picture position. The steps may also include dividing the source picture and the determined padding area(s) into a plurality of LCTUs based on the determined source picture position. The steps may also include partitioning LCTUs of the plurality of LCTUs to form the prepared coding units.

According to a fifth principle of the invention, there is a method for decoding. The method may include receiving video compression data. The method may also include processing the received video compression data utilizing a processor. The received video compression data may be based on coding units, based on source pictures. The coding units may be prepared by steps including calculating an efficiency measure associated with at least one potential source picture position in a coordinate system based on fitting the coordinate system and at least one source picture with respect to each other, The coordinate system may include two perpendicular axes in a plane intersecting at an origin of the coordinate system and dividing the plane into four quadrants meeting at the origin. The steps may also include determining a source picture position for the source picture in the coordinate system based on the calculated efficiency measure, the potential source picture position and a coding efficiency goal. The steps may also include determining one or more padding area(s) based on the determined source picture position. The steps may also include dividing the source picture and the determined padding area(s) into a plurality of LCTUs based on the determined source picture position. The steps may also include partitioning LCTUs of the plurality of LCTUs to form the prepared coding units.

According to a sixth principle of the invention, there is a CRM storing computer readable instructions which, when executed by a computer system, performs a method for decoding. The method may include receiving video compression data. The method may also include processing the received video compression data utilizing a processor. The received video compression data may be based on coding units, based on source pictures. The coding units may be prepared by steps including calculating an efficiency measure associated with at least one potential source picture position in a coordinate system based on fitting the coordinate system and at least one source picture with respect to each other, The coordinate system may include two perpendicular axes in a plane intersecting at an origin of the coordinate system and dividing the plane into four quadrants meeting at the origin. The steps may also include determining a source picture position for the source picture in the coordinate system based on the calculated efficiency measure, the potential source picture position and a coding efficiency goal. The steps may also include determining one or more padding area(s) based on the determined source picture position. The steps may also include dividing the source picture and the determined padding area(s) into a plurality of LCTUs based on the determined source picture position. The steps may also include partitioning LCTUs of the plurality of LCTUs to form the prepared coding units.

These and other objects are accomplished in accordance with the principles of the invention in providing systems, methods and CRMs which code and decode utilizing picture boundary padding. Further features, their nature and various advantages will be more apparent from the accompanying drawings and the following detailed description of the preferred embodiments.

### BRIEF DESCRIPTION OF THE DRAWINGS

Features of the examples and disclosure are apparent to those skilled in the art from the following description with reference to the figures, in which:

FIG. 1 is a block diagram illustrating a coding system and a decoding system utilizing picture boundary variability, according to an example;

FIG. 2 is a graph showing a fixed picture boundary with picture boundary padding in a coordinate system, according to an example;

FIG. 3 is a partially offset picture boundary with picture boundary padding in a coordinate system, according to an example;

FIG. 4 is a fully offset picture boundary with picture boundary padding in a coordinate system, according to an example;

FIG. 5 is a flow diagram illustrating a method for preparing coding units utilizing picture boundary padding, according to an example;

FIG. 6 is a flow diagram illustrating a method for coding utilizing picture boundary padding, according to an example;

FIG. 7 is a flow diagram illustrating a method for decoding utilizing picture boundary padding, according to an example; and

FIG. 8 is a block diagram illustrating a computer system to provide a platform for a system for coding and/or a system for decoding utilizing picture boundary padding, according to examples.

### DETAILED DESCRIPTION

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some methods and structures have not been described in detail so as not to unnecessarily obscure the description. Furthermore, different embodiments are described below. The embodiments may be used or performed together in different combinations.

As used herein, the term “includes” means “includes at least” but is not limited to the term “including only”. The term “based on” means “based at least in part on”. The term “picture” means a picture which is either equivalent to a frame or equivalent to a field associated with a frame, such as a field which is one of two sets of interlaced lines of an interlaced video frame. The term “coding” may refer to the encoding of an uncompressed video bitstream. The term “coding” may also refer to transcoding a compressed video bitstream from one compressed format to another.

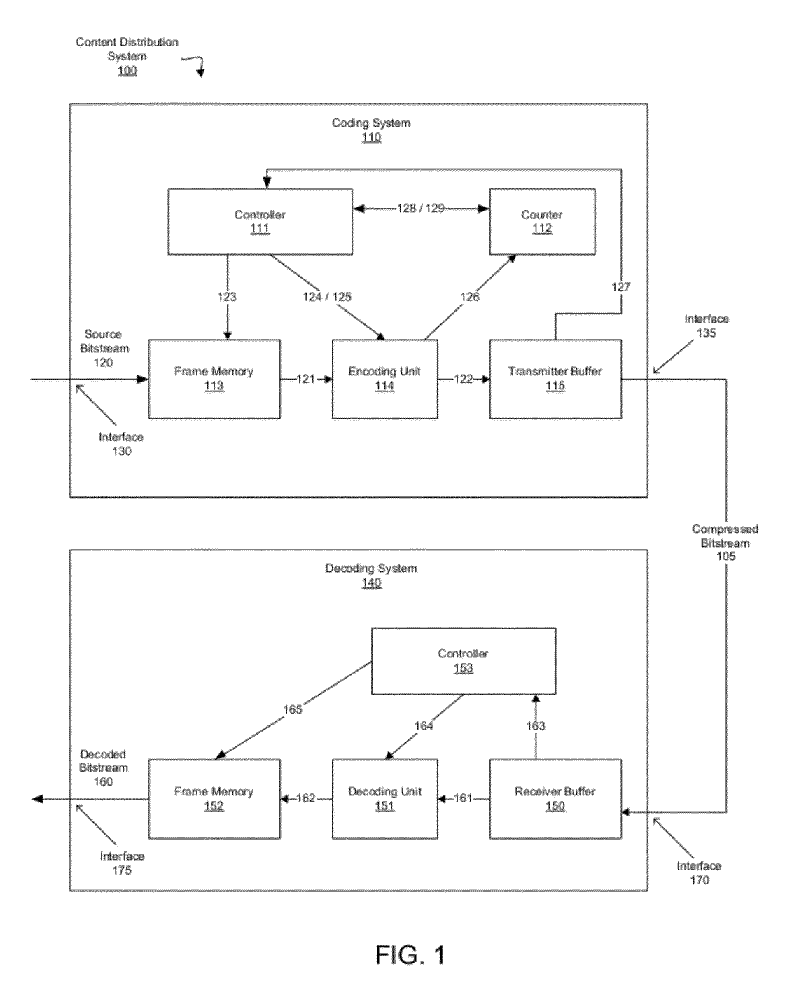

As demonstrated in the following examples and embodiments, there are systems, methods, and machine readable instructions stored on computer-readable media (e.g., CRMs) for coding and decoding utilizing picture boundary padding. Referring to FIG. 1, there is disclosed a content distribution system 100 including a coding system 110 and a decoding system 140 utilizing picture boundary padding associated with preparing coding units from video frames or pictures. The prepared coding units are utilized in generating video compression data, according to an example. The coding system 110 and a decoding system 140 are described in greater detail below after the following detailed description of picture boundary padding.

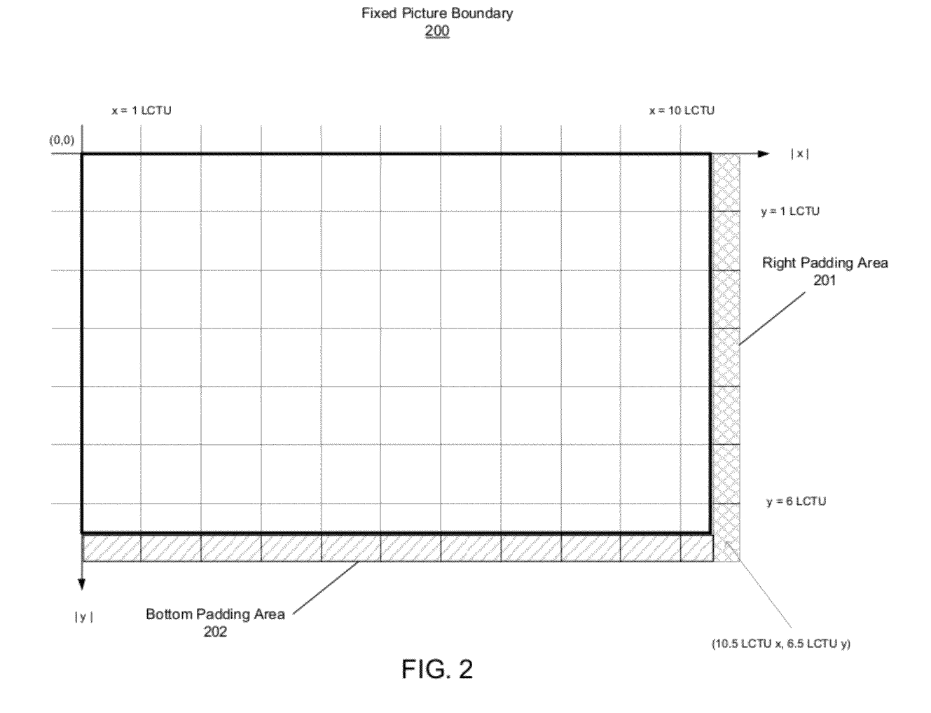

FIG. 2 is an example of a picture which may be partitioned based on largest coding tree units (LCTUs) according to a default mode. In the default mode, the origin of the superimposed coordinate system, as a coordinate system locus, is always located at a corner of a fixed picture boundary, as a source picture locus, which may be fitted to the coordinate system in a plane. In FIG. 2, the source picture locus associated with the upper left corner of a picture coincides with the coordinate system locus occurring at the origin (0,0) of the superimposed coordinates system. It occurs in the default mode so as to coincide with a corner of a source picture corner largest coding tree unit (i.e., an LCTU which occurs at a corner of the source picture) in the plurality of largest coding tree units associated with a source picture. The default mode may be selected based upon an efficiency measure which determines the picture position is most efficient based on such factors as a homogeneity goal and/or boundary issues.

Referring to FIG. 2, there is disclosed a fixed picture boundary 200 (i.e., the bold line rectangle) of the picture. The periphery of a picture, such as a picture in a video sequence, may be described by the fixed picture boundary 200. The coordinate system may have an origin (0,0), a horizontal “x-axis” and a vertical “y-axis”. The fixed picture boundary 200 may be superimposed by a single quadrant of the coordinate system. The quadrant may be described by the two axes of the coordinate system.

Each of the axes may be described by a number line marked by equivalent line lengths separating marking points along each number line. The intersections of lines perpendicular to each marking point may describe a corner of a polygon, such as a square, a rectangle etc. Each polygon may represent an LCTU associated with an area of a picture within the fixed picture boundary 200. Each side of the polygon may represent an LCTU side length. The marking points of the number line describing each axis may be an absolute value of a multiple of a value of an LCTU side length. For example, all the pictures in a video sequence may be partitioned by first being divided up into square LCTUs having an LCTU size, such as 64×64 pixels, 128×128 pixels, etc.

In the example of FIG. 2, the fixed picture boundary 200 and the coordinate system are fixed in their location with respect to each other. The coordinate system describing the locations of the LCTUs is superimposed over the fixed picture boundary 200 such that the x-axis and y-axis of a single quadrant of the coordinate system always coincide with a side of the picture boundary of the pictures. In this circumstance, the origin (0,0) of the coordinate system also coincides with a corner of the picture boundary 200. The LCTUs near to the origin are filled with a corresponding square area of the picture associated with the fixed picture boundary 200. The LCTUs in the column and row farthest from the origin are only partially filled by an area of the picture. These partially filled LCTUs are boundary issue LCTUs.

The coordinate system used in determining the location of the LCTUs may always be superimposed this way with respect to source pictures. If no other consideration is made with respect the placement of the coordinate system with respect to a picture boundary of a source picture, then the boundary issue LCTUs determined by the placement may generate a greater number coding units before the quad tree format leaves in the boundary issue LCTUs are partitioned iteratively to form square shaped leaves that are filled and/or before a homogeneity rule is reached with respect to the pixels within the coding units of these LCTUs.

A greater numbers of smaller coding units may be required to reach a homogeneity rule if the placement of LCTUs fails to take into consideration the location of objects in the pictures of the video sequence. Or in another example, this may also occur if the placement of LCTUs fails to consider the location of motion within the pictures of the video sequence. In either circumstance, the partitioning of the LCTUs may result in a greater number of smaller coding units requiring more overhead to generate and process all the coding units associated with a picture. Also more bandwidth may be required to transmit compression data associated with the greater number of smaller coding units when packaged in a compressed video bitstream.

FIG. 2 depicts a default mode according to an example showing a fixed picture boundary 200. In the default mode depicted in FIG. 2, all the LCTUs nearer to the axes of the coordinate system superimposed on the fixed picture boundary 200 are associated with an area of a picture which completely fill the square area of these LCTUs. However, the LCTUs which occur at the 11^{th} LCTU along the x-axis are boundary issue LCTUs. The LCTUs which occur at the 7^{th} LCTU along the y-axis are also boundary issue LCTUs. A boundary issue LCTU is an incomplete or partially filled LCTU and may have any portion that is less than 100% of its LCTU area associated with a picture. According the example exemplified in FIG. 2, the boundary issue LCTUs have 50% or less of their LCTU area associated with any part of a picture in the video sequence. Note that the boundary issue LCTU located at the outer corner of the fixed picture boundary 200 occurring at (10.5 LCTU x, 6.5 LCTU y) has only 25% of its LCTU area associated with any part of a picture. The default mode may be selected based upon a determination of a homogeneity goal associated with pixels in prepared coding units. However, if the placement of the fixed picture boundary 200 is made without consideration of the boundary issue in partitioning these LCTUs, this may also result in generating a larger number of smaller coding units.

However, a potential boundary issue for the default mode source picture positioning depicted in FIG. 2 is addressed by picture boundary padding. The picture boundary padding in FIG. 2 includes a right padding area 201 and a bottom padding area 202, according to an example. The lower right corner LCTU may be padded as shown in FIG. 2, or the padding areas may overlap, etc. The padding areas operate to address the boundary issue by adding pixel values for the pixel areas of the padding areas, which are otherwise absent of pixels, in the incomplete LCTU areas of each of the boundary issue LCTUs. The added pixel values may simply repeat the last recorded pixel value for a boundary issue LCTU, and/or a dummy pixel value may be utilized. The boundary issue LCTUs are then partitioned without preliminary iterative partitioning to form square shaped leaves that are filled. Note that among the padding areas depicted in FIG. 2, right padding area 201 includes a locus at (11 LCTU x, 7 LCTU y) which coincides with a farthest from the origin corner of a farthest from the origin source picture corner LCTU. In the default mode, the locus coinciding with the farthest from the origin corner of a farthest from the origin source picture corner LCTU is part of a padding area.

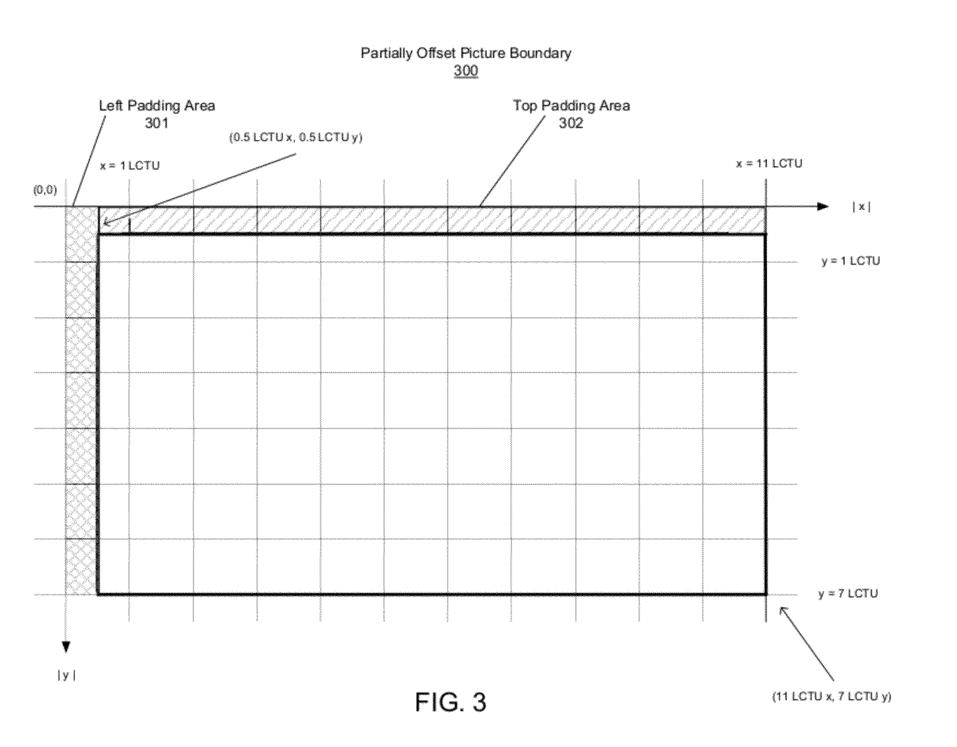

Referring to FIG. 3, there is shown a partially offset picture boundary 300 as an example of a picture which may be flexibly partitioned according to a corner mode. In the corner mode, LCTUs may be located with respect to the pictures based upon a determination of a homogeneity goal associated with pixels in prepared coding units. The determination includes some consideration of a location of a coordinate system with respect to a picture upon which it is superimposed. The determination of the homogeneity goal may include consideration of numerous factors, including the location of objects or motion in the pictures of the video sequence. In the corner mode, a first locus of the source picture position occurs at a nearest to the origin corner of a first source picture corner largest coding tree unit located nearest to the origin. The first locus may be separated from the origin of the coordinate system by an offset distance. In FIG. 3, the first locus occurs at (0.5 LCTU x, 0.5 LCTU y). According to an example, the corner mode may coincide with the default mode. In this circumstance, the first locus coincides with the origin. In the corner mode, a second locus coincides with a corner of a second source picture corner LCTU also coinciding with a farthest from the origin corner of a second source picture corner LCTU. In FIG. 3, one second locus occurs at (11 LCTU x, 7 LCTU y). Other second loci may occur at the other two source picture corner LCTUs. In FIG. 3, these appear at (11 LCTU x, 1 LCTU y) and (0.5 LCTU x, 7 LCTU y). All these second loci coincide with a line intersection forming a corner of an LCTU at a source picture corner.

A potential boundary issue in FIG. 3 is addressed by picture boundary padding including a left padding area 301 and a top padding area 302, according to an example. The upper left source picture corner LCTU, which is a boundary issue LCTU, may be padded as shown in FIG. 3, or the padding areas may overlap, etc. The boundary issue LCTUs are then partitioned without preliminary iterative partitioning to form square shaped leaves that are filled. The coordinate system the pictures associated with the picture boundary and the padding areas are otherwise as described above with respect to FIG. 2. Note that among the padding areas depicted in FIG. 3, left padding area 301 includes a locus at (0,0) which coincides with the origin. In the corner mode, the locus coinciding with the origin is part of a padding area.

In the corner mode, the outside corner of the picture boundary which is located furthest from the origin of the coordinate system may be fitted to an outside corner of an LCTU in the coordinate system based on a determination that the shifting of the picture boundary placement away from the origin will increase coding efficiency. In the partially offset picture boundary 300, a coordinate system locus and a picture boundary locus coincide at the coordinate pair (11 LCTU x, 7 LCTU y). The corner mode increases coding efficiency while utilizing very little overhead. According to an example, the corner mode may require only 2 bits of overhead to indicate directions of the horizontal shift and/or the vertical shift associated with the partially offset picture boundary 300 in the coordinate system.

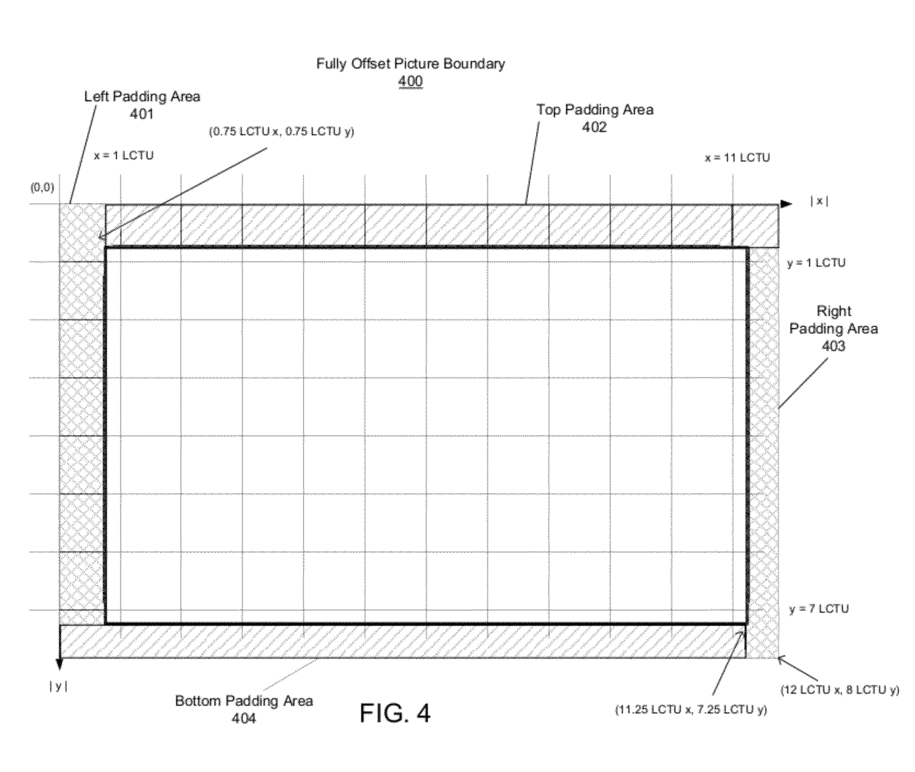

Referring to FIG. 4, there is shown a fully offset picture boundary 400 (i.e., the bold line rectangle), as an example of a picture which may be flexibly partitioned according to an explicit mode. The periphery of a picture in the coordinate system may be described by the fully offset picture boundary 400. A potential boundary issue in FIG. 4 is addressed by picture boundary padding including a left padding area 401, a top padding area 402, a right padding area 403 and a bottom padding area 404, according to an example. The source picture corner boundary issue LCTUs may be padded as shown in FIG. 4, or the padding areas may overlap, etc. The boundary issue LCTUs are then partitioned without preliminary iterative partitioning to form square shaped leaves that are filled. The coordinate system and the picture, and the padding areas are otherwise as described above with respect to FIG. 2 and FIG. 3. Note that among the padding areas depicted in FIG. 4, left padding area 401 includes a locus at (0,0) which coincides with the origin and right padding area 403 includes a locus at (12 LCTU x, 8 LCTU y). These loci coincide with one of the origin of the coordinate system and a point, coinciding with a farthest from the origin corner of a farthest from the origin source picture corner LCTU. In the explicit mode, at least one of these two loci may be found in a padding area.

In the example demonstrated in FIG. 4, the pictures associated with the coordinate system are free located with respect to each other. Based on the homogeneity determination, the fully offset picture boundary 400 may be shifted away from the origin (0,0) and/or the LCTU sides as shown in FIG. 4. The explicit mode includes highly precise placement of the fully offset picture boundary 400 and may be set at any desired accuracy, such as a 1 pixel interval, a 4 pixels interval, an 8 pixels interval, a 16 pixel interval, etc. Picture analysis may be utilized to determine an offset vector for flexible partitioning in the explicit mode. The offset vector may include positioning the picture within the quadrant by an angular orientation of a side of the picture boundary with respect to an axis of the two axes, such as rotating the picture in the plane of the coordinate system within the quadrant so as to increase the coding efficiency based on some aspect such as texture or motion associated with a feature of the picture, such as an object or background in the picture.

Flexible partitioning utilizing picture boundary padding may improve coding efficiency as the prepared coding units are more likely to be fitted to picture content in source pictures without increasing boundary issue inefficiencies. For example, a source picture may contain a simple background area at the bottom and a more detailed area to the top. In this circumstance, flexible partitioning utilizing picture boundary padding may prepare larger coding units associated with the background in the bottom of the source picture and thus provide higher coding efficiency without increasing boundary issue inefficiencies. A coding system or device may analyze picture content to determine picture boundary offsets and boundary padding area coding criteria to improve the flexible partitioning of the source picture.

Referring again to FIG. 1, the coding system 110 includes an input interface 130, a controller 111, a counter 112, a frame memory 113, an encoding unit 114, a transmitter buffer 115 and an output interface 135. The decoding system 140 includes a receiver buffer 150, a decoding unit 151, a frame memory 152 and a controller 153. The coding system 110 and the decoding system 140 are coupled to each other via a transmission path including a compressed bitstream 105. The controller 111 of the coding system 110 controls the amount of data to be transmitted on the basis of the capacity of the receiver buffer 150 and may include other parameters such as the amount of data per a unit of time. The controller 111 controls the encoding unit 114, to prevent the occurrence of a failure of a received signal decoding operation of the decoding system 140. The controller 111 may be a processor or include, for example, a microcomputer having a processor, a random access memory and a read only memory.

A source bitstream 120 supplied from, for example, a content provider may include a video sequence of frames including source pictures in the video sequence. The source bitstream 120 may be uncompressed or compressed. If the source bitstream 120 is uncompressed, the coding system 110 may be associated with an encoding function. If the source bitstream 120 is compressed, the coding system 110 may be associated with a transcoding function. Coding units may be derived from the source pictures utilizing the controller 111. The frame memory 113 may have a first area which may used for storing the incoming source pictures from the source bitstream 120 and a second area may be used for reading out the source pictures and outputting them to the encoding unit 114. The controller 111 may output an area switching control signal 123 to the frame memory 113. The area switching control signal 123 may indicate whether the first area or the second area is to be utilized.

The controller 111 outputs an encoding control signal 124 to the encoding unit 114. The encoding control signal 124 causes the encoding unit 114 to start an encoding operation such as preparing the coding units based on a source picture. In response to the encoding control signal 124 from the controller 111, the encoding unit 114 starts to read out the prepared coding units to a high-efficiency encoding process, such as a prediction coding process or a transform coding process which process the prepared coding units generating video compression data based on the source pictures associated with the coding units.

The encoding unit 114 may package the generated video compression data in a packetized elementary stream (PES) including video packets. The encoding unit 114 may map the video packets into an encoded video signal 122 using control information and a program time stamp (PTS) and the encoded video signal 122 may be signaled to the transmitter buffer 115.

The encoded video signal 122 including the generated video compression data may be stored in the transmitter buffer 114. The information amount counter 112 is incremented to indicate the total amount of data in the transmitted buffer 115. As data is retrieved and removed from the buffer, the counter 112 may be decremented to reflect the amount of data in the transmitter buffer 114. The occupied area information signal 126 may be transmitted to the counter 112 to indicate whether data from the encoding unit 114 has been added or removed from the transmitted buffer 115 so the counter 112 may be incremented or decremented. The controller 111 may control the production of video packets produced by the encoding unit 114 on the basis of the occupied area information 126 which may be communicated in order to prevent an overflow or underflow from taking place in the transmitter buffer 115.

The information amount counter 112 may be reset in response to a preset signal 128 generated and output by the controller 111. After the information counter 112 is reset, it may count data output by the encoding unit 114 and obtain the amount of video compression data and/or video packets which has been generated. Then, the information amount counter 112 may supply the controller 111 with an information amount signal 129 representative of the obtained amount of information. The controller 111 may control the encoding unit 114 so that there is no overflow at the transmitter buffer 115.

The decoding system 140 includes an input interface 170, a receiver buffer 150, a controller 153, a frame memory 152, a decoding unit 151 and an output interface 175. The receiver buffer 150 of the decoding system 140 may temporarily store the compressed bitstream 105 including the received video compression data and video packets based on the source pictures from the source bitstream 120. The decoding system 140 may read the control information and presentation time stamp information associated with video packets in the received data and output a frame number signal 163 which is applied to the controller 153. The controller 153 may supervise the counted number of frames at a predetermined interval, for instance, each time the decoding unit 151 completes a decoding operation.

When the frame number signal 163 indicates the receiver buffer 150 is at a predetermined capacity, the controller 153 may output a decoding start signal 164 to the decoding unit 151. When the frame number signal 163 indicates the receiver buffer 150 is at less than a predetermined capacity, the controller 153 may wait for the occurrence of a situation in which the counted number of frames becomes equal to the predetermined amount. When the frame number signal 163 indicates the receiver buffer 150 is at the predetermined capacity, the controller 153 may output the decoding start signal 164. The encoded video packets and video compression data may be decoded in a monotonic order (i.e., increasing or decreasing) based on presentation time stamps associated with the encoded video packets.

In response to the decoding start signal 164, the decoding unit 151 may decode data amounting to one picture associated with a frame and compressed video data associated with the picture associated with video packets from the receiver buffer 150. The decoding unit 151 may write a decoded video signal 162 into the frame memory 152. The frame memory 152 may have a first area into which the decoded video signal is written, and a second area used for reading out a decoded bitstream 160 to the output interface 175.

The different modes described above associated with picture boundary padding (e.g., default mode, corner mode, explicit mode) may be implemented through the HEVC models under consideration through a syntax change to headers of video packets in the compressed bitstream 105. The syntax changes may be implemented at different layers of a video sequence, such as at the sequence, picture and/or slice layer.

TABLE I shows a syntax change, highlighted in boldface, which may be implemented in an HEVC header at the sequence layer.

TABLE I
Syntax change at sequence layer.

| | | |
|---|---|---|
| seq_parameter_set_rbsp( ) { | C | Descriptor |
| profile_idc | 0 | u(8) |
| reserved_zero_8bits /* equal to 0 */ | 0 | u(8) |
| level_idc | 0 | u(8) |
| seq_parameter_set_id | 0 | ue(v) |
| bit_depth_luma_minus8 | 0 | ue(v) |
| bit_depth_chroma_minus8 | 0 | ue(v) |
| increased_bit_depth_luma | 0 | ue(v) |
| ine_bit_depth_chroma | 0 | ue(v) |
| log2_max_frame_num_minus4 | 0 | ue(v) |
| log2_max_pic_order_cnt_lsb_minus4 | 0 | ue(v) |
| max_num_ref_frames | 0 | ue(v) |
| gaps_in_frame_num_value_allowed_flag | 0 | u(1) |
| log2_min_coding_unit_size_minus3 | 0 | ue(v) |
| max_coding_unit_hierarchy_depth | 0 | ue(v) |
| log2_min_transform_unit_size_minus2 | 0 | ue(v) |
| max_transform_unit_hierarchy_depth | 0 | ue(v) |
| pic_width_in_luma_samples | 0 | u(16) |
| pic_height_in_luma_samples | 0 | u(16) |
| arbitrarily_padding_enable_flag | 1 | u(1) |
| If (arbitrarily_padding_enable_flag){ | | |
| arbitrarily_padding_mode | 1 | u(1) |
| If (arbitrarily_padding_mode == corner mode) { | | |
| corner_padding_flag | 1 | u(2) |
| } | | |
| else if (arbitrarily_padding_mode == explicit mode) { | | |
| { | | |
| right_padding_size | 1 | ue(v) |
| left_padding_size | 1 | ue(v) |
| top_padding_size | 1 | ue(v) |
| bottom_padding_size | 1 | ue(v) |
| } | | |
| } | | |
| numExtraFilters | 0 | ue(v) |
| for(i=0; i< numExtraFilters; i++){ | | |
| log2_filterCoeffPrecision | 0 | ue(v) |
| halfNumTap | 0 | ue(v) |
| for(j=0;j<(3*halfNumTap); j++){ | | |
| filterCoef[i][j] | 0 | i(v) |
| } | | |
| } | | |
| rbsp_trailing_bits( ) | 0 | |
| } | | |

TABLE II shows a syntax change, highlighted in boldface, which may be implemented in an HEVC header at the picture layer.

TABLE II
Syntax change at picture layer.

| | | |
|---|---|---|
| pic_parameter_set_rbsp( ) { | C | Descriptor |
| pic_parameter_set_id | 1 | ue(v) |
| seq_parameter_set_id | 1 | ue(v) |
| entropy_coding_mode_flag | 1 | u(1) |
| num_ref_idx_I0_default_active_minus1 | 1 | ue(v) |
| num_ref idx_I1_default_active_minus1 | 1 | ue(v) |
| pic_init_qp_minus26 /* relative to 26 */ | 1 | se(v) |
| constrained_intra_pred_flag | 1 | u(1) |
| arbitrarily_padding_enable_flag | 1 | u(1) |
| If (arbitrarily_padding_enable_flag){ | | |
| arbitrarily_padding_mode | 1 | u(1) |
| If (arbitrarily_padding_mode == corner mode) { | | |
| corner_padding_flag | 1 | u(2) |
| } | | |
| else if (arbitrarily_padding_mode == explicit mode) { | | |
| { | | |
| right_padding_size | 1 | ue(v) |
| left_padding_size | 1 | ue(v) |
| top_padding_size | 1 | ue(v) |
| bottom_padding_size | 1 | ue(v) |
| } | | |
| } | | |
| for(i=0;i<15; i++){ | | |
| numAllowedFilters[i] | 1 | ue(v) |
| for(j=0;j<numAllowedFilters;j++){ | | |
| filtldx[i][j] | 1 | ue(v) |
| } | | |
| } | | |
| rbsp_trailing_bits( ) | 1 | |
| } | | |

TABLE III shows a syntax change, highlighted in boldface, which may be implemented in an HEVC header at the slice layer.

TABLE III
Syntax change at slice layer.

| | | |
|---|---|---|
| slice_header( ) { | C | Descriptor |
| first_Ictb_in_slice | 2 | ue(v) |
| slice_type | 2 | ue(v) |
| pic_parameter_set_id | 2 | ue(v) |
| frame_num | 2 | u(v) |
| if( IdrPicFlag ) | | |
| idr_pic_id | 2 | ue(v) |
| pic_order_cnt_Isb | 2 | u(v) |
| if( slice_type = = P \| \| slice_type = = B ) { | | |
| num_ref_idx_active_override_flag | 2 | u(1) |
| if( num_ref_idx_active_overrideflag ) { | | |
| num_ref_idx_I0_active_minus1 | 2 | ue(v) |
| if( slice_type = = B ) | | |
| num_ref_idx_I1_active_minus1 | 2 | ue(v) |
| } | | |
| } | | |
| arbitrarily_padding_enable_flag | 1 | u(1) |
| If (arbitrarily_padding_enable_flag){ | | |
| arbitrarily_padding_mode | 1 | u(1) |
| If (arbitrarily_padding_mode == corner mode) { | | |
| corner_padding_flag | 1 | u(2) |
| } | | |
| else if (arbitrarily_padding_mode == explicit mode) { | | |
| { | | |
| right_padding_size | 1 | ue(v) |
| left_padding_size | 1 | ue(v) |
| top_padding_size | 1 | ue(v) |
| bottom_padding_size | 1 | ue(v) |
| } | | |
| } | | |
| if( nal_ref idc != 0 ) | | |
| dec_ref_pic_marking( ) | 2 | |
| if( entropy_coding_mode_flag && slice_type != I ) | | |
| cabac_init_idc | 2 | ue(v) |
| slice_qp_delta | 2 | se(v) |
| alf_param( ) | | |
| if( slice_type = = P \| \| slice_type = = B ){ | | |
| mc_interpolation_idc | 2 | ue(v) |
| mv_competition_flag | 2 | u(1) |
| if ( mv_competition_flag ) { | | |
| mv_competition_temporal_flag | 2 | u(1) |
| } | | |
| } | | |
| if ( slice_type = = B && mv_competition_flag) | | |
| collocated_from_I0_flag | 2 | u(1) |
| sifo_param( ) | | |
| if (entropy_coding_mode_flag == 3) | | |
| parallel_v2v_header( ) | 2 | |
| edge_based_prediction_flag | 2 | u(1) |
| if( edge_prediction_ipd_flag = = 1 ) | | |
| threshold_edge | 2 | u(8) |
| } | | |

Semantics which may be utilized with the syntax changes in TABLES I-III include Arbitrarily_padding_enable_flag specifies whether the arbitrarily padding is used in the sequence, picture and/or slice. When arbitrarily padding is disabled (arbitrarily_padding_enable_flag equals 0), the all padding parameters are set to zero. They also include Arbitrarily_padding_mode which specifies the padding mode of the sequence, picture and/or slice. When corner mode (mode 0) is used, padding parameters are set to a fixed distance determined by corner_padding_flag.

If corner_padding_flag is equal to 0, a picture is padded so that its original top left corner LCTU aligns with top left corner of input picture. This may imply that top_padding_size and left_padding_size are set to zero.

If corner_padding_flag is equal to 1, a picture is padded so that its original top right corner LCTU aligns with top right corner of input picture. This may imply that top padding_size is set to zero and left_padding_size is set to pic_height_in_luma_samples−MaxCodingUnitSize*[pic_height_in_luma_samples/MaxCodingUnitSize].

If corner_padding_flag is equal to 2, a picture is padded so that its original bottom left corner LCTU aligns with bottom left corner of input picture. This may imply that left_padding_size is set to zero and top_padding_size is set to pic_width_in_luma_samples−MaxCodingUnitSize*[pic_width_in_luma_samples/MaxCodingUnitSize].

If corner_padding_flag is set to 3, a picture is padded so that its original bottom right corner LCTU aligns with bottom right corner of input picture. This may imply that top_padding_size is set to pic_height_in_luma_samples−MaxCodingUnitSize*[pic_height_in_luma_samples/MaxCodingUnitSize] and left_padding_size is set to pic_width_in_luma_samples−MaxCodingUnitSize*[pic_width_in_luma_samples/MaxCodingUnitSize].

When explicit mode (mode 1) is used, an input picture may be padded by an amount indicated by right_padding_size and left_padding_size horizontally and top_padding_size and bottom_padding_size vertically.

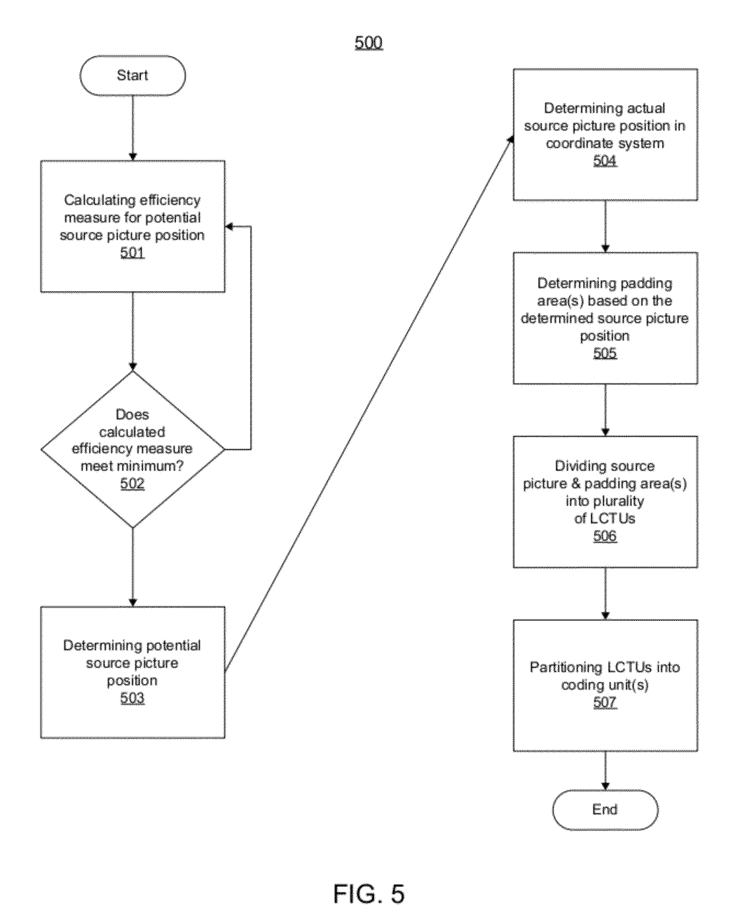

According to different examples, the coding system 110 may be incorporated or otherwise associated with a transcoder or an encoding apparatus at a headend and the decoding system 140 may be incorporated or otherwise associated with a downstream device, such as a mobile device, a set top box or a transcoder. These may be utilized separately or together in methods of coding and/or decoding utilizing picture boundary padding in preparing coding units. Various manners in which the coding system 110 and the decoding system 140 may be implemented are described in greater detail below with respect to FIGS. 5, 6 and 7, which depict flow diagrams of methods 500, 600 and 700.

Method 500 is a method for preparing coding units utilizing picture boundary padding. Method 600 is a method for coding utilizing coding units prepared utilizing picture boundary padding. Method 700 is a method for decoding utilizing compression data generated utilizing picture boundary padding. It is apparent to those of ordinary skill in the art that the methods 500, 600 and 700 represent generalized illustrations and that other steps may be added and existing steps may be removed, modified or rearranged without departing from the scope of the methods 500, 600 and 700. The descriptions of the methods 500, 600 and 700 are made with particular reference to the coding system 110 and the decoding system 140 depicted in FIG. 1. It should, however, be understood that the methods 500, 600 and 700 may be implemented in systems and/or devices which differ from the coding system 110 and the decoding system 140 without departing from the scope of the methods 500, 600 and 700.

With reference to the method 500 in FIG. 5, at step 501, the controller 111 associated with the coding system 110 calculates an efficiency measure associated with a potential source picture position in a coordinate system based on fitting the coordinate system and the source picture with respect to each other.

At step 502, the controller 111 determines if the calculated efficiency measure meets a minimum efficiency measure associated with a coding efficiency goal.

At step 503, if the calculated efficiency measure meets the minimum efficiency measure, the controller 111 determines a potential source picture position in the coordinate system based on the calculated efficiency measure, the source picture and the coordinate system.

At step 504, the controller 111 determines an actual source picture position based on one or more of the determined potential source picture positions and the coding efficiency goal.

At step 505, the controller 111 and the encoding unit 114 determine padding area(s) based on the determined source picture position.

At step 506, the controller 111 divides the source picture and the determined padding area(s) into a plurality of LCTUs based on the determined actual source picture position.

At step 507, the controller 111 partitions the largest coding tree units of the plurality of LCTUs into at least one coding unit based on the tree format and a homogeneity rule associated with the pixels in the coding units.

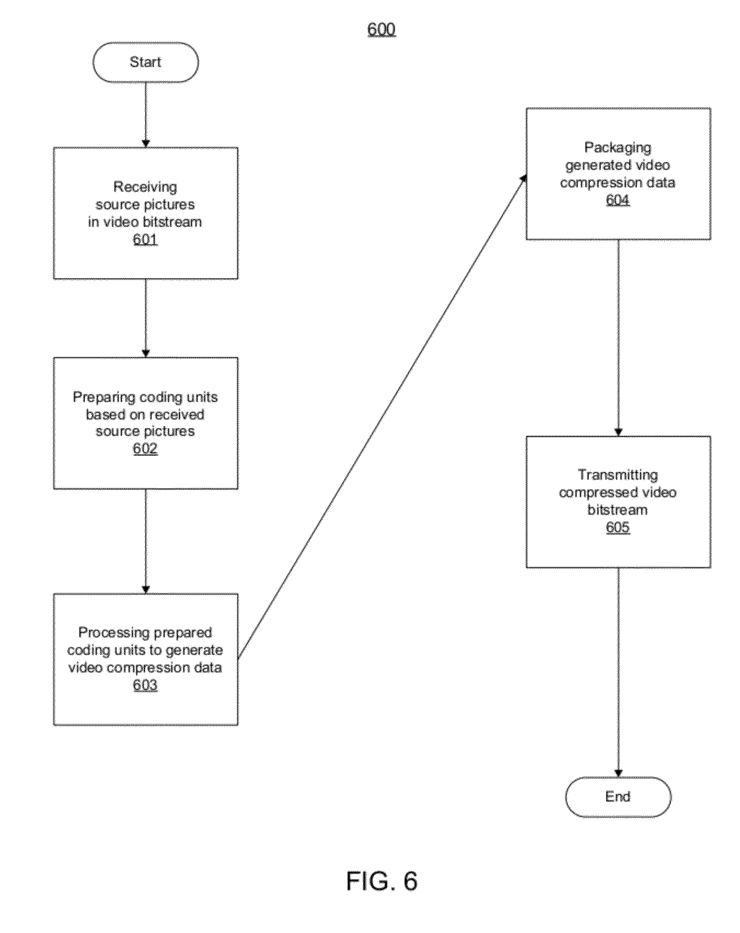

With reference to the method 600 in FIG. 6, at step 601, the interface 130 and the frame memory 113 of the coding system 110 receive the source bitstream 120 including source pictures.

At step 602, the controller 111 prepares coding units based on the received source pictures. The preparing may be performed as described above with respect to method 500.

At step 603, the controller 111 and the encoding unit 114 process the prepared coding units generating video compression data based on the processed coding units.

At step 604, the controller 111 and the encoding unit 114 package the generated video compression data.

At step 605, the controller 111 and the transmitter buffer 115 transmit the packaged video compression data in compressed bitstream 105 via the interface 135.

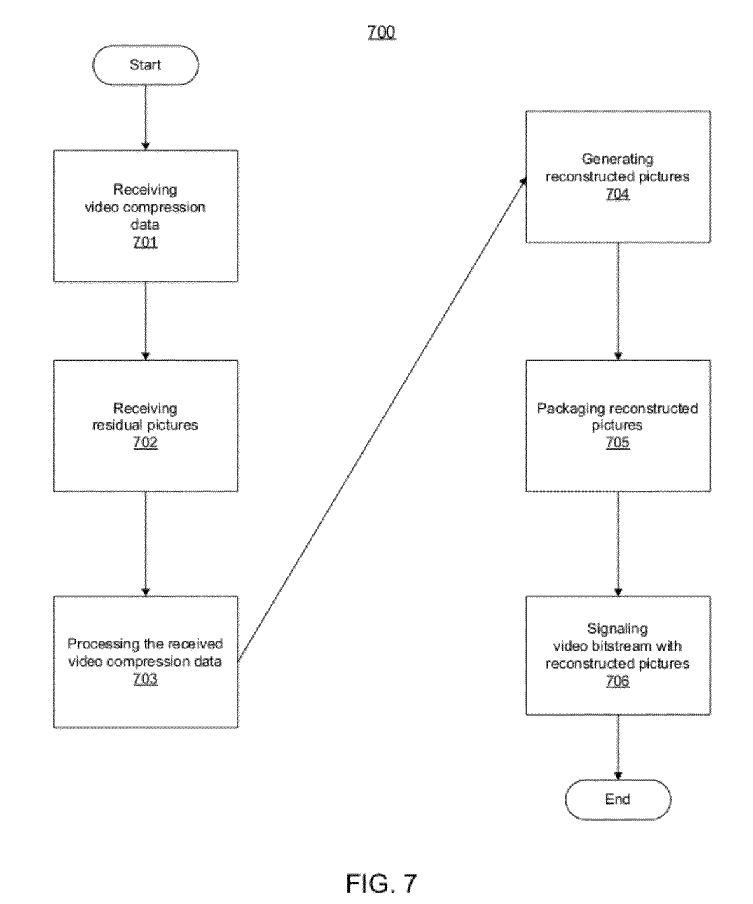

With reference to the method 700 in FIG. 7, at step 701, the decoding system 140 receives the compressed bitstream 105 including the video compression data via the interface 170 and the receiver buffer 150.

At step 702, the decoding system 140 receives residual pictures associated with the video compression data via the interface 170 and the receiver buffer 150.

At step 703, the decoding unit 151 and the controller 153 process the received video compression data.

At step 704, the decoding unit 151 and the controller 153 generate reconstructed pictures based on the processed video compression data and the received residual pictures.

At step 705, the decoding unit 151 and the controller 153 package the generated reconstructed pictures and signal them to the frame memory 152.

At step 706, the controller 153 signals the generated reconstructed pictures in the decoded signal 180 via the interface 175.

Some or all of the methods and operations described above may be provided as machine readable instructions, such as a utility, a computer program, etc., stored on a computer readable storage medium, which may be non-transitory such as hardware storage devices or other types of storage devices. For example, they may exist as program(s) comprised of program instructions in source code, object code, executable code or other formats.

An example of a computer readable storage media includes a conventional computer system RAM, ROM, EPROM, EEPROM, and magnetic or optical disks or tapes. Concrete examples of the foregoing include distribution of the programs on a CD ROM. It is therefore to be understood that any electronic device capable of executing the above-described functions may perform those functions enumerated above.

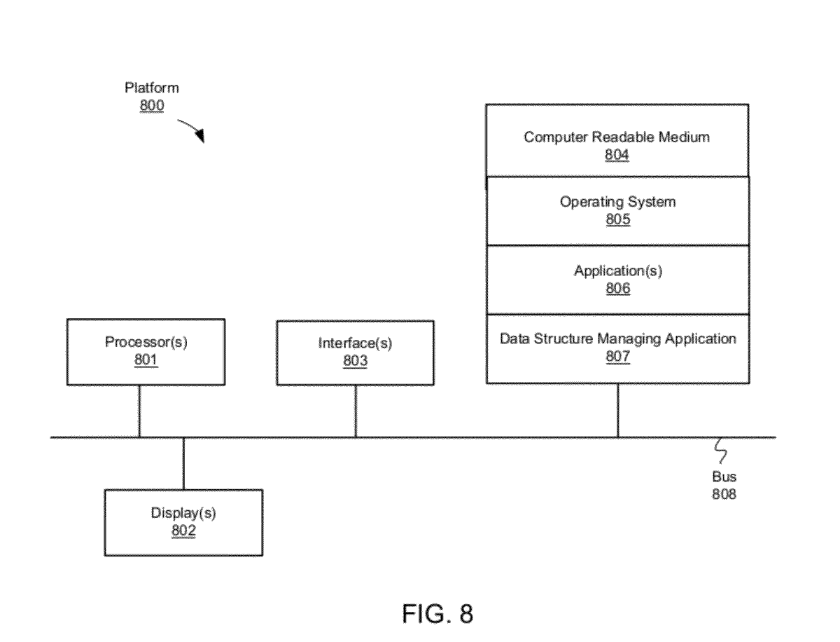

Referring to FIG. 8, there is shown a platform 800, which may be employed as a computing device in a system for coding or decoding utilizing picture boundary padding, such as coding system 100 and/or decoding system 200. The platform 800 may also be used for an upstream encoding apparatus, a transcoder, or a downstream device such as a set top box, a handset, a mobile phone or other mobile device, a transcoder and other devices and apparatuses which may utilize picture boundary padding and associated coding units prepared based on picture boundary padding. It is understood that the illustration of the platform 800 is a generalized illustration and that the platform 800 may include additional components and that some of the components described may be removed and/or modified without departing from a scope of the platform 800.

The platform 800 includes processor(s) 801, such as a central processing unit; a display 802, such as a monitor; an interface 803, such as a simple input interface and/or a network interface to a Local Area Network (LAN), a wireless 802.11x LAN, a 3G or 4G mobile WAN or a WiMax WAN; and a computer-readable medium 804. Each of these components may be operatively coupled to a bus 808. For example, the bus 808 may be an EISA, a PCI, a USB, a FireWire, a NuBus, or a PDS.

A computer readable medium (CRM), such as CRM 804 may be any suitable medium which participates in providing instructions to the processor(s) 801 for execution. For example, the CRM 804 may be non-volatile media, such as an optical or a magnetic disk; volatile media, such as memory; and transmission media, such as coaxial cables, copper wire, and fiber optics. Transmission media can also take the form of acoustic, light, or radio frequency waves. The CRM 804 may also store other instructions or instruction sets, including word processors, browsers, email, instant messaging, media players, and telephony code.

The CRM 804 may also store an operating system 805, such as MAC OS, MS WINDOWS, UNIX, or LINUX; applications 806, network applications, word processors, spreadsheet applications, browsers, email, instant messaging, media players such as games or mobile applications (e.g., “apps”); and a data structure managing application 807. The operating system 805 may be multi-user, multiprocessing, multitasking, multithreading, real-time and the like. The operating system 805 may also perform basic tasks such as recognizing input from the interface 803, including from input devices, such as a keyboard or a keypad; sending output to the display 802 and keeping track of files and directories on CRM 804; controlling peripheral devices, such as disk drives, printers, image capture devices; and managing traffic on the bus 808. The applications 806 may include various components for establishing and maintaining network connections, such as code or instructions for implementing communication protocols including TCP/IP, HTTP, Ethernet, USB, and FireWire.

A data structure managing application, such as data structure managing application 807 provides various code components for building/updating a computer readable system (CRS) architecture, for a non-volatile memory, as described above. In certain examples, some or all of the processes performed by the data structure managing application 807 may be integrated into the operating system 805. In certain examples, the processes may be at least partially implemented in digital electronic circuitry, in computer hardware, firmware, code, instruction sets, or any combination thereof.

According to principles of the invention, there are systems, methods, and computer readable mediums (CRMs) which provide for coding and decoding utilizing picture boundary variability in preparing coding units. By utilizing picture boundary variability, LCTUs may be located freely with respect to a picture so that their associated coding units may be partitioned so as to increase the coding efficiencies associated with processing overhead and/or bandwidth required by the systems, methods, and CRMs for coding and decoding utilizing picture boundary variability.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. A system for coding, the system comprising a processor configured to prepare coding units based on source pictures,
the preparing including
calculating an efficiency measure associated with at least one potential source picture position in a coordinate system based on fitting the coordinate system and at least one source picture with respect to each other,
wherein the coordinate system includes two perpendicular axes in a plane intersecting at an origin of the coordinate system and dividing the plane into four quadrants meeting at the origin,
determining a source picture position for the source picture in the coordinate system based on the calculated efficiency measure, the potential source picture position and a coding efficiency goal,
determining at least one padding area based on the determined source picture position, and
dividing the source picture and the determined at least one padding area into a plurality of largest coding tree units based on the determined source picture position.

2. The system of claim 1, wherein
the source picture is in the shape of a polygon having four corners,
the coordinate system and the determined source picture position are both located in one plane,
a plurality of equivalently spaced axially perpendicular lines are located along the two axes of the coordinate system,
a plurality of pairs of perpendicular lines in the plurality of lines, have line intersections coinciding with corners of the largest coding tree units in the plurality of largest coding tree units, and
the determined at least one padding area includes pixels having a predetermined pixel value.

3. The system of claim 2, wherein
the source picture is in the shape of a rectangle,
the complete determined source picture position is located within a single quadrant of the coordinate system,
a locus of the determined source picture position, coinciding at a corner of a source picture corner largest coding tree unit in the plurality of largest coding tree units, coincides with the origin of the coordinate system, and
a locus of the determined at least one padding area coincides with a farthest from the origin corner of a farthest from the origin source picture corner largest coding tree unit of the plurality of largest coding tree units.

4. The system of claim 2, wherein
the source picture is in the shape of a rectangle,
the complete determined source picture position is located within a single quadrant of the coordinate system,
a first locus of the determined source picture position,
coinciding with a nearest to the origin corner of a first source picture corner largest coding tree unit located nearest to the origin of the plurality of largest coding tree units,
is separated from the origin of the coordinate system by an offset distance,
a second locus of the determined source picture position,
coinciding with a farthest from the origin corner of a second source picture corner largest coding tree unit of the plurality of largest coding tree units,
coincides with a line intersection of a pair of the plurality of pairs of perpendicular lines in the plurality of lines having line intersections coinciding with corners of the largest coding tree units in the plurality of largest coding tree units, and
a locus of the determined at least one padding area coincides with the origin of the coordinate system.

5. The system of claim 2, wherein
the source picture is in the shape of a rectangle,
the complete determined source picture position is located within a single quadrant of the coordinate system,
a first locus of the determined source picture position,
coinciding with a nearest to the origin corner of a nearest to the origin source picture corner largest coding tree unit in the plurality of largest coding tree units,
is separated from the origin of the coordinate system by an offset distance,
a second locus of the determined source picture position,
coinciding with a farthest from the origin corner of a farthest from the origin source picture corner largest coding tree unit in the plurality of largest coding tree units,
is separated by an offset distance from a line intersection of a pair of the plurality of pairs of perpendicular lines in the plurality of lines having line intersections coinciding with corners of the largest coding tree units in the plurality of largest coding tree units, and
a locus of the determined at least one padding area coincides with one of
the origin of the coordinate system, and
a point, coinciding with a farthest from the origin corner of a farthest from the origin source picture corner largest coding tree unit of the plurality of largest coding tree units.

6. The system of claim 5, wherein the offset distance associated with the second locus is equivalent to a number of pixels.

7. The system of claim 1, wherein the coding efficiency goal is at least one of
a predetermined homogeneity measure of the prepared coding units associated with at least one aspect of at least one feature of the source picture, and
a predetermined maximum number of prepared coding units based on the source picture.

8. The system of claim 1, wherein the determined source picture position includes an angular orientation of a side of the polygon of the source picture with respect to an axis of the two axes.

9. A method for coding, the method comprising preparing coding units based on source pictures utilizing a processor;
the preparing including
calculating an efficiency measure associated with at least one potential source picture position in a coordinate system based on fitting the coordinate system and at least one source picture with respect to each other,
wherein the coordinate system includes two perpendicular axes in a plane intersecting at an origin of the coordinate system and dividing the plane into four quadrants meeting at the origin,
determining a source picture position for the source picture in the coordinate system based on the calculated efficiency measure, the potential source picture position and a coding efficiency goal,
determining at least one padding area based on the determined source picture position, and
dividing the source picture and the determined at least one padding area into a plurality of largest coding tree units based on the determined source picture position.

10. A non-transitory computer readable medium storing computer readable instructions that when executed by a computer system perform a method for coding, the method comprising:
preparing coding units based on source pictures utilizing a processor;
the preparing including
calculating an efficiency measure associated with at least one potential source picture position in a coordinate system based on fitting the coordinate system and at least one source picture with respect to each other,
wherein the coordinate system includes two perpendicular axes in a plane intersecting at an origin of the coordinate system and dividing the plane into four quadrants meeting at the origin,
determining a source picture position for the source picture in the coordinate system based on the calculated efficiency measure, the potential source picture position and a coding efficiency goal,
determining at least one padding area based on the determined source picture position, and
dividing the source picture and the determined at least one padding area into a plurality of largest coding tree units based on the determined source picture position.

11. A system for decoding, the system comprising:
an interface configured to receive video compression data; and
a processor configured to process the received video compression data,
wherein the received video compression data is based on coding units, based on source pictures, and the coding units are prepared by steps including
calculating an efficiency measure associated with at least one potential source picture position in a coordinate system based on fitting the coordinate system and at least one source picture with respect to each other,
wherein the coordinate system includes two perpendicular axes in a plane intersecting at an origin of the coordinate system and dividing the plane into four quadrants meeting at the origin,
determining a source picture position for the source picture in the coordinate system based on the calculated efficiency measure, the potential source picture position and a coding efficiency goal,
determining at least one padding area based on the determined source picture position, and
dividing the source picture and the determined at least one padding area into a plurality of largest coding tree units based on the determined source picture position, and
partitioning largest coding tree units of the plurality of largest cording tree units to form the prepared coding units.

12. The system of claim 11, wherein
the source picture is in the shape of a polygon having four corners,
the coordinate system and the determined source picture position are both located in one plane,
a plurality of equivalently spaced axially perpendicular lines are located along the two axes of the coordinate system,
a plurality of pairs of perpendicular lines in the plurality of lines, have line intersections coinciding with corners of the largest coding tree units in the plurality of largest coding tree units, and
the determined at least one padding area includes pixels having a predetermined pixel value.

13. The system of claim 12, wherein
the source picture is in the shape of a rectangle,
the complete determined source picture position is located within a single quadrant of the coordinate system,
a locus of the determined source picture position, coinciding at a corner of a source picture corner largest coding tree unit in the plurality of largest coding tree units, coincides with the origin of the coordinate system, and
a locus of the determined at least one padding area coincides with a farthest from the origin corner of a farthest from the origin source picture corner largest coding tree unit of the plurality of largest coding tree units.

14. The system of claim 12, wherein
the source picture is in the shape of a rectangle,
the complete determined source picture position is located within a single quadrant of the coordinate system,
a first locus of the determined source picture position,
coinciding with a nearest to the origin corner of a first source picture corner largest coding tree unit located nearest to the origin of the plurality of largest coding tree units, and
separated from the origin of the coordinate system by an offset distance, and
a second locus of the determined source picture position,
coinciding with a farthest from the origin corner of a second source picture corner largest coding tree unit of the plurality of largest coding tree units,
coinciding with a line intersection of a pair of the plurality of pairs of perpendicular lines in the plurality of lines having line intersections coinciding with corners of the largest coding tree units in the plurality of largest coding tree units and
a locus of the determined at least one padding area coincides with the origin of the coordinate system.

15. The system of claim 12, wherein
the source picture is in the shape of a rectangle,
the complete determined source picture position is located within a single quadrant of the coordinate system,
a first locus of the determined source picture position,
coinciding with a nearest to the origin corner of a nearest to the origin source picture corner largest coding tree unit in the plurality of largest coding tree units,
is separated from the origin of the coordinate system by an offset distance, and
a second locus of the determined source picture position,
coinciding with a farthest from the origin corner of a farthest from the origin source picture corner largest coding tree unit in the plurality of largest coding tree units,
is separated by an offset distance from a line intersection of a pair of the plurality of pairs of perpendicular lines in the plurality of lines having line intersections coinciding with corners of the largest coding tree units in the plurality of largest coding tree units, and
a locus of the determined at least one padding area coincides with one of
the origin of the coordinate system, and
a point, coinciding with a farthest from the origin corner of a farthest from the origin source picture corner largest coding tree unit of the plurality of largest coding tree units.

16. The system of claim 15, wherein the offset distance associated with the second locus is equivalent to a number of pixels.

17. The system of claim 11, wherein the coding efficiency goal is at least one of
a predetermined homogeneity measure of the prepared coding units associated with at least one aspect of at least one feature of the source picture, and
a predetermined maximum number of prepared coding units based on the source picture.

18. The system of claim 11, wherein the determined source picture position includes an angular orientation of a side of the polygon of the source picture with respect to an axis of the two axes.

19. A method for decoding, the method comprising:
receiving video compression data; and
processing the received video compression data utilizing a processor,
wherein the received video compression data is based on coding units, based on source pictures, and the coding units are prepared by steps including
calculating an efficiency measure associated with at least one potential source picture position in a coordinate system based on fitting the coordinate system and at least one source picture with respect to each other,
wherein the coordinate system includes two perpendicular axes in a plane intersecting at an origin of the coordinate system and dividing the plane into four quadrants meeting at the origin,
determining a source picture position for the source picture in the coordinate system based on the calculated efficiency measure, the potential source picture position and a coding efficiency goal,
determining at least one padding area based on the determined source picture position,
dividing the source picture and the determined at least one padding area into a plurality of largest coding tree units based on the determined source picture position, and
partitioning largest coding tree units of the plurality of largest cording tree units to form the prepared coding units.

20. A non-transitory computer readable medium storing computer readable instructions that when executed by a computer system perform a method for decoding, the method comprising:
receiving video compression data; and
processing the received video compression data utilizing a processor,
wherein the received video compression data is based on coding units, based on source pictures, and the coding units are prepared by steps including
calculating an efficiency measure associated with at least one potential source picture position in a coordinate system based on fitting the coordinate system and at least one source picture with respect to each other,
wherein the coordinate system includes two perpendicular axes in a plane intersecting at an origin of the coordinate system and dividing the plane into four quadrants meeting at the origin,
determining a source picture position for the source picture in the coordinate system based on the calculated efficiency measure, the potential source picture position and a coding efficiency goal,
determining at least one padding area based on the determined source picture position,
dividing the source picture and the determined at least one padding area into a plurality of largest coding tree units based on the determined source picture position, and
partitioning largest coding tree units of the plurality of largest cording tree units to form the prepared coding units.
